(19) United States
(12) Patent Application Publication
(10) Pub. No.: US 2016/0245901 A1
(43) Pub. Date: Aug. 25, 2016

(54) OPTOELECTRONIC SENSOR AND METHOD FOR THE DETECTION OF OBJECTS

(71) Applicant: SICK AG, Waldkirch (DE)

(72) Inventor: Fabian JACHMANN, Waldkirch (DE)

(21) Appl. No.: 15/041,625

(22) Filed: Feb. 11, 2016

(30) Foreign Application Priority Data
Feb. 20, 2015 (EP) 15 15 5879.8

(51) Int. Cl. G01S 7/484; G01S 7/486; G01S 17/10

(52) U.S. Cl. CPC G01S 7/484; G01S 17/10; G01S 7/4865

(57) ABSTRACT

An optoelectronic sensor (10) for the detection of objects in a monitoring area (20) comprises a light transmitter (12) for transmitting a light signal (16) into the monitoring area (20), a light receiver (26) for converting the light signal (22) reflected or remitted by an object into an electrical reception signal, a supplementary circuit (38) for operating the light receiver (26), and an evaluation (32) which is configured to determine a reception level of the reception signal and to determine object information about the object from the reception signal, wherein the evaluation unit (32) is further configured to determine the reception level from measurement information in the supplementary circuit (36, 38).

The invention relates to an optoelectronic sensor and a method for the detection of objects in a monitoring area.

A common task in the detection of objects with an optoelectronic sensor is distance determination. Light time of flight methods are known where light signals are transmitted and the time until the reception of the light signals remitted or reflected by objects is measured. Due to the constant velocity of propagation of the signal, the signal time of flight can directly be converted into a distance.

A precondition for an accurate signal time of flight measurement is a precise determination of the reception time. Various methods for that end are known. In a phase method, a periodically modulated signal is transmitted, and the phase shift between transmitted and received signal is determined. A pulse method uses a signal allowing a precise time determination. The detection is carried out by comparator thresholds in simple implementations, while in more complex methods the entire reception signal is sampled and digitally evaluated in order to localize the reception pulse. A pulse averaging method transmits a plurality of transmission pulses and statistically evaluates the pulses subsequently received. A particularly efficient and precise averaging method for a one-dimensional distance scanner is disclosed in DE 10 2007 013 714 A1. WO 2012 084 298 A1 relates to a corresponding laser scanner.

A major problem in optical distance measuring is the high dynamics of the reception signal. The reception level significantly varies, mainly due to two factors, namely, the reflectance of the probed object and the object distance. The reflectance may be in a range of a few percent for a black target and even above one hundred percent for a retroreflector. The reception level decreases with the square of the distance for a Lambert target. This results in a dynamic range over many orders of magnitude.

Different reflectance does not only increase the dynamic range, but also distorts the shape of the reception signal. Therefore, a color or level correction of the measured distance in dependence on the actual reflectance of a detected object is usually performed which, however, requires the reception level to be known. A corresponding level measurement would require a sampling of the reception signal at least with several thresholds or an A/D converter of sufficient bit depth which, however, are technically complex as compared to a simple threshold method or the pulse averaging according to DE 10 2007 013 714 A1 based on a binarization.

Several approaches to deal with the large dynamic range are known in the prior art. Use of non-linear or logarithmic amplifiers is conceivable, which, however, for the required processing of pulses in the nanosecond range do not exist with sufficient bandwidth. EP 1 990 657 A1 tries to introduce a non-linear damping via the characteristic of a PIN diode, but this leads to technical difficulties in adapting to the downstream amplifier.

In EP 2 182 377 A1, the dynamic range is distributed onto several reception channels with complementary amplification ranges. However, there is a considerable increase in hardware complexity if at least two reception channels need to be sampled with a high temporal resolution.

In the German patent application with application number 10 2014 102 209, as yet unpublished, an additional reception channel is implemented in that the voltage drop in the supply of the light receiver during the reception of a light signal is used as an additional measurement signal. However, this signal also needs to be detected with a high temporal resolution so that the hardware complexity as compared to two conventional dedicated reception channels is not sufficiently reduced.

It is therefore an object of the invention to simplify the precise evaluation of a reception signal of a light receiver.

This object is satisfied by an optoelectronic sensor for the detection of objects in a monitoring area, the sensor comprising a light transmitter for transmitting a light signal into the monitoring area, a light receiver for converting the light signal reflected or remitted by an object into an electrical reception signal, a supplementary circuit for operating the light receiver, and an evaluation which is configured to determine a reception level of the reception signal and to determine object information about the object from the reception signal, wherein the evaluation unit is further configured to determine the reception level from measurement information in the supplementary circuit.

The sensor transmits a light signal in a usual way, converts the returned light signal in a light receiver, in particular in an APD (Avalanche Photo Diode), into an electrical reception signal, which is evaluated. The invention starts from the basic idea to also determine the reception level, but not from the reception signal of the light receiver. Instead, measurement information from a supplementary circuit for operating the light receiver, which anyway usually is present, is used for determining the reception level

The object is also satisfied by a method for the detection of objects in a monitoring area, wherein a light signal is transmitted into the monitoring area and a light signal reflected or remitted by an object is converted into an electrical signal in a light receiver, wherein a reception level of the reception signal is determined and the reception signal is evaluated to determine object information about the object, while the reception level is determined from measurement information of a supplementary circuit for operating the light receiver.

The invention has the advantage that the dynamic range is expanded in a particularly cost-effective manner. In the supplementary circuit, measurement information can be obtained with very simple means which allow determination of the reception level. The actual measurement in the reception channel based on the signal of the light receiver is not at all affected, but can of course be corrected based on the reception level and thus be improved in its accuracy.

The supplementary circuit preferably comprises a voltage supply of the light receiver. Throughout this specification, preferably refers to a preferred, but completely optional feature. In particular, in case of an APD as the light receiver, the voltage supply is a high voltage supply. Preferably, the use of this voltage supply during the reception of light signals is obtained as the measurement information.

The supplementary circuit preferably comprises a capacitor for providing charge for pulse responses of the light receiver. This parallel capacity thus provides the required energy for pulse responses in a single pulse method or a pulse averaging method. Here, the charge flowing during the reception of light signals or the corresponding current, respectively, is used as measurement information.

The evaluation unit preferably is configured to compare the reception level with an expected reception level of a reflector. This can for example be done in a threshold comparison with a threshold which is set or taught on the basis of a typical reflector signal.

Then, it is conceivable to merely determine a binary reception level, i.e. whether the probed object is a reflector or not. This may already be valuable object information in itself which is output or otherwise used, for example if reflectors are used as markers.

Preferably, a current measuring unit is connected with the supplementary circuit. Then, the measurement information used for obtaining the reception level is the current which flows while the light receiver receives the light signal. A particularly cost-effective and at the same time reliable way of current measurement is possible with a shunt resistor.

The evaluation unit preferably is configured to determine a reception point in time of the light signal based on the reception signal and thus a distance of the object with a light time of flight method. In this case, the distance is the object information to be determined or at least part of the object information to be determined. While in principle any known light time of flight method is conceivable, the invention is particularly advantageous in connection with a pulse method and in particular with a pulse averaging method.

The evaluation unit preferably is configured to make a correction based on the reception level during determination of the distance. For that purpose, a relation between reception levels and distance corrections is known, for example in the form of a table. It is also possible to use only a fixed correction value for the detection of reflectors.

The evaluation preferably is configured to select an evaluation algorithm for the light time of flight method in dependence on the reception level. Then, the reception level is not only a correction parameter, but a change of the evaluation algorithm takes place. For example, it is changed between an evaluation algorithm for reflecting and non-reflecting objects. For example, the reception point in time for a non-reflecting object can be identified by a different characteristic than for a reflecting object, for example at an edge instead of at a zero.

The evaluation unit preferably is configured to transmit a plurality of light pulses and to average the reception signals which are subsequently generated. This means use of a pulse averaging method, in particular with a specific analog preprocessing and only binary detection of reception signals, as for example described in DE 10 2007 013 714 A1 or WO 201 2 084 298 A1 hereby incorporated by reference.

A low pass filter is preferably at least indirectly connected with the supplementary circuit, by means of which the measurement information is detected in an averaged manner. This is preferably done when the evaluation method is a pulse averaging method, because there the reception level has to be measured only relatively slowly over a longer period of time and several individual pulses. The time constant of the low pass filter is preferably adapted to the measurement period, i.e. that period during which a distance value is determined, and not to the shorter period of the individual pulses contributing to a pulse averaging. Thus, no detection of measurement information with high temporal resolution is necessary for the reception level, and a considerably more cost-effective sampling per measurement period is sufficient.

Preferably a test circuit is provided, which feeds an artificial test signal corresponding to a high reception level into the supplementary circuit or the current measurement unit, respectively. The test signal in particular is an artificial reflector signal. The evaluation thus can check whether the determination of the reception level is reliable, which provides the required failure safety required in applications of safety technology. For testing the current measurement unit for use in safety technology, a high reflectance reference target can also be used which is located in an angular region of the scan which is not used for the evaluation of the safety-related measurement data.

The sensor preferably is configured as laser scanner having a deflection unit by means of which the light signal periodically scans the monitoring area. Laser scanners are often used for an area monitoring, and due to the large monitoring area there is a particularly large probability to encounter reflecting or at least strongly remitting objects.

The inventive method can be modified in a similar manner and shows similar advantages. The measurement information is preferably obtained by a current measurement based on a shunt resistor in the supplementary circuit and/or after a low pass filtering. Further advantageous features are described in the sub claims following the independent claims in an exemplary, but non-limiting manner.

The invention will be explained in the following also with respect to further advantages and features with reference to exemplary embodiments and the enclosed drawing. The Figures of the drawing show in:

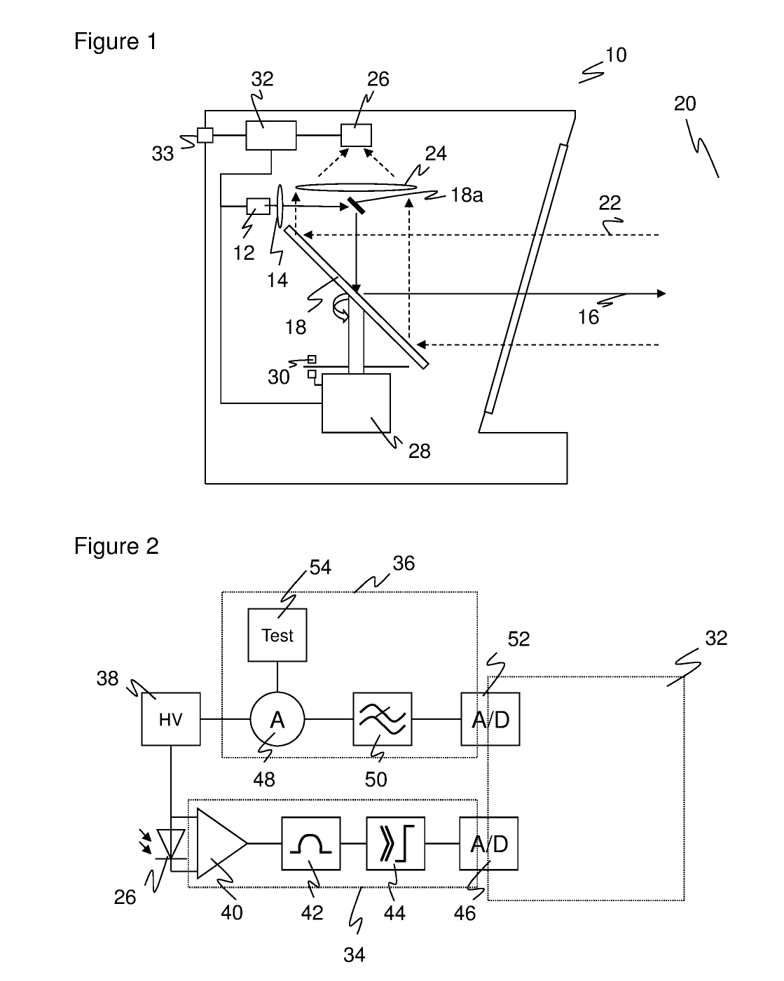

FIG. 1 a schematic sectional view of a laser scanner;

FIG. 2 a block diagram of the reception channel and a supplementary circuit with reception level measurement in the laser scanner of FIG. 1; and

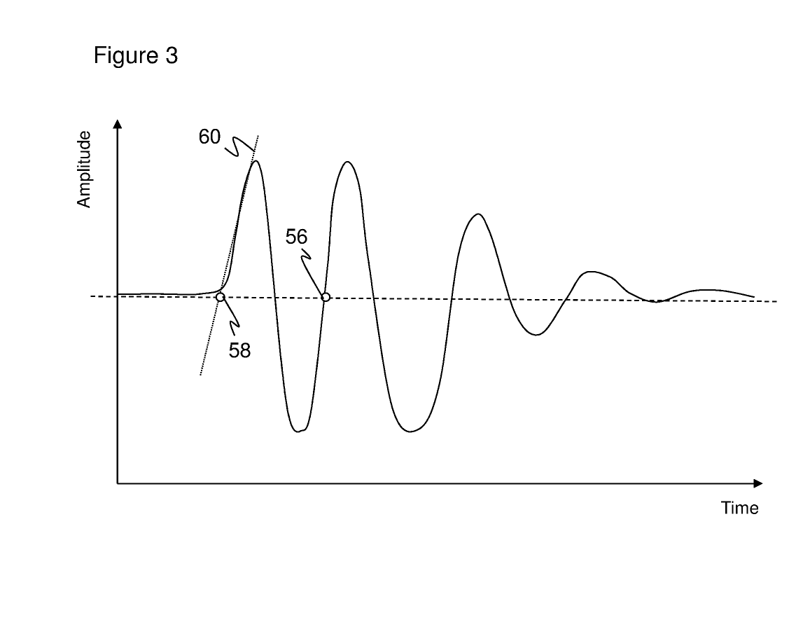

FIG. 3 an exemplary temporal profile of a reception signal in the laser scanner of

FIG. 1 for explaining a change of the evaluation method in dependence on the reception level.

FIG. 1 shows a schematic sectional view through a laser scanner 10. A light transmitter 12, for example having a laser light source, generates a transmission light beam 16 by means of transmission optics 14. The transmission light beam 16 is transmitted into a monitoring area 20 via a mirror 18a and a movable deflection unit 18, and is remitted by an object. The remitted light 22 returns to the laser scanner 10 and is detected via the deflection unit 18 and by means of reception optics 24 in a light receiver 26, for example a photo diode or, for higher sensitivity, an avalanche photo diode (APD).

The deflection unit 18 is rotated by a motor 28 in a continuous rotational movement at a scan frequency. Therefore, the transmission light beam 16 scans a plane during each scan period, i.e. a complete revolution at the scan frequency. At the outer circumference of the deflection unit 18, an angle measuring unit 30 is arranged in order to detect the respective angular position of the deflection unit 18. The angle measuring unit 30 is formed by a line coded disk as the angular measurement body and a forked light barrier for its detection by way of example.

An evaluation unit 32 is connected to the light transmitter 12, the light receiver 26, the motor 28 and the angle measuring unit 30. The evaluation unit 32 measures the light time of flight between transmitting the transmission light beam 16 and receiving the remitted light 22 in order to obtain the distance of a probed object from the laser scanner 10 using the speed of light. The respective angular position where the transmission light beam 16 was transmitted is known to the evaluation unit 32 from the angle measuring unit 30. Here, light time of flight is negligible as compared to usual frequencies of rotation of the deflection unit 18 so that the transmission light beam 16 is transmitted at virtually the same angle as the corresponding remitted light 22 is received.

Thus, after each scanning period, with angle and distance, two-dimensional polar coordinates of all object positions in the monitoring area 20 are available. Therefore, the object positions or object contours, respectively, are known and can be transmitted via an interface 33 or be displayed at the laser scanner 10. The interface 33 can also be used as a parametrization interface where data can be transferred to the evaluation unit 32. As an alternative, a separate parameterization interface is provided. The laser scanner 10 has a housing comprising a circumferential front screen.

Laser scanners 10 which are constructed in a different manner than shown in FIG. 1 are also known. A laser scanner 10 is anyway only one example of an optoelectronic sensor according to the invention.

The laser scanner 10 can in particular be used in safety technology for monitoring a source of danger, such as a dangerous machine. Then, a protective field that must not be entered by personnel during operation of the machine is monitored. The laser scanner 10 triggers an emergency stop in case that it detects an inadmissible intrusion into a protective field, such as a leg of a person. In these applications of safety technology, the interface 33 may be configured in a safe manner, in particular as a safe output (OSSD, Output Signal Switching Device) for a safety-related shutdown signal upon detection of an intrusion into a protective field.

Sensors used in safety technology have to work particularly reliably and must therefore meet strong safety requirements, for example the standard EN13849 for machine safety and the device standard IEC61496 or EN61496 for non-contact protective devices.

In order to comply with these safety standards, a number of measures need to be taken, such as safe electronic evaluation by redundant, diverse electronics, function monitoring or in particular a monitoring of contaminations of optical components, in particular of the front screen 38, and/or provision of individual test targets of defined reflectance which have to be detected at the respective scan angles.

FIG. 2 shows a block diagram of the reception path of the laser scanner 10, from which FIG. 1 only shows the light receiver 26 and the evaluation unit 32 for the sake of simplicity. In the embodiment according to FIG. 2, the actual evaluation unit 32 is implemented digitally, for example on an FPGA (Field Programmable Gate Array) or a comparable device. An analog preprocessing path 34 as well as a reception level determination unit 36 may also be part of the evaluation unit. In principle, a simple analog evaluation for example by a threshold comparison is possible.

A voltage supply 38 supplies the light receiver 26 and is an example for a supplementary circuit for operating the light receiver 26. The reception level determination unit 36 is also connected with the voltage supply 38. Thus, the reception level determination unit 36 expressly does not operate on the basis of the reception signal of the light receiver 26.

The light time of flight can be measured in the evaluation unit 32 by any known method.

A pulse averaging method is preferred, where reception signals for a plurality of transmitted individual pulses are accumulated and added. This results in an improved signal-to-noise ratio. Moreover, this is advantageous in connection with the reception level measurement based on the voltage supply 38 according to the invention, because the reception level can be measured relatively slowly as it is usually sufficient to know the average reception level during the determination of a distance value.

FIG. 2 shows as an example the reception path of a particular pulse averaging method similar to the one describe in DE 10 2007 013 714 A1 or WO 2012 084 298 A1 which are incorporated by reference for further details. In other light time of flight methods, the analog preprocessing path 34 may not exist or be replaced by a simple amplification.

The analog preprocessing path 34 includes a preamplifier 40, a filter 42 and a limiting amplifier 44 as well as an A/D converter 46 as a transition to the digital evaluation unit 32. Preamplifier 40 and filter 42 may also be arranged in reverse order. The preamplifier 40, for example a transimpedance amplifier, generates a corresponding preamplified voltage signal from the photo current of the light receiver 26. Each individual pulse of the pulse averaging pulse, being a light signal, is always unipolar. The corresponding unipolar reception signal of the light receiver 26 is converted into a bipolar oscillation signal by the filter 42, for example a band pass filter, and subsequently is amplified into saturation and cut off by limiting amplifier 44. Therefore, an A/D converter 46 configured as a binarizer is sufficient for the digitizing and can be implemented by simple comparators in particular in the inputs of the FPGA of the digital evaluation unit 32. By adding of measurement repetitions, an averaged digital reception signal results. The adding of bit sequences can also be understood as an accumulation of events in a histogram, which in the course of the repetitions represents the averaged reception signal in a discrete form. An advantage of this implementation of the light time of flight method is that very cost-efficient components can be used, and the averaged reception signal enables a robust detection of the reception point in time even if the individual pulse does not have a discernable difference between useful signal and noise.

In the example shown in FIG. 2, the reception level determination unit 36 measures the average current flowing in the voltage supply 38 while the light receiver 26 receives the remitted light 22. Depending on the transmission power, this current, in particular for reflector targets, is one or two orders of magnitude stronger than those values caused by ambient light, and therefore allows an easy distinction. In principle, a different parameter related to the reception level may also be determined.

For this purpose, a current measuring unit 48 is provided for the power supply 38, which can be implemented particularly cost-efficient as a voltage measurement at a low-impedance measurement resistor (shunt resistor). The signal of the current measurement unit 48 is averaged with a low pass filter 50. The time constant of the low pass filter 50 preferably is set so that the current is averaged over a measurement period, i.e. that period during which individual pulses are transmitted, received again, and accumulated in a histogram in order to determine a distance value. While the reception signal for the light time of flight measurement needs to be sampled in the GHz range by the A/D converter 46 in order to detect the very short light times of flight, a relatively slow A/D converter 52 of for example 10-50 KHz is sufficient in the reception level determination unit 36, because the reception level needs only to be known on average over the individual pulses of a distance measurement.

In particular in applications of safety technology, a test generator circuit 54 is additionally provided which generates an artificial test signal upon a corresponding trigger, the test signal representing in its level an object of a determined reflectance such as a reflector. This has to be detected as a reflector signal for proving correct functioning.

The reception level determination unit 36 thus provides the reception level for the evaluation unit 32, in addition to the actual reception signal of the light receiver 26 and the preprocessing path 34, respectively. This reception level is used for a color or level correction of the distance value in the evaluation unit 32. To that end, a relation of reception level, being a measure of the reflectance of the probed object, and a distance correction is stored in the evaluation unit 32.

In some embodiments, exact level information of the reception level determination unit 36 is not required, but only a reflector is to be detected. Only if a reflector, in particular a retroreflector, is detected, the distance is corrected accordingly. Detection of the reflector may be done in a comparison with an expected reception level of a reflector which already has been set as the binarization threshold in the A/D converter 52, which in this case is configured as a comparator.

The reception level may additionally or alternatively be used for other modifications of the distance measurement than only a level correction. For example, it is possible to select the evaluation algorithm in dependence on the reception level as measured. For example, light times of flight to a reflector are evaluated differently than to other objects.

As an illustration, FIG. 3 shows a purely exemplary profile of the reception signal received by the evaluation unit 32 from the analog preprocessing path 34. Due to the oscillation caused by the filter 42, the shape of the reception signal is not simply a distorted repetition of the transmission pulse, but roughly a sine signal with decaying amplitude. The reception signal provides a plurality of characteristics such as zeros, extremes or inflection points where the reception point in time can be clearly defined. For example, for small or moderate reception levels, the zero 56 could be used. However, in case the evaluation unit 32 already knows from the reception level, without any detailed knowledge of the reception signal, that a reflector has been detected, it may be useful to change this criterion, for example in order to look for a characteristic of the reception signal which is level-independent. This is indicated in FIG. 3 by a position 58 of a first edge of the reception signal shown by an interpolating line. The reception level, in this case binary information whether a reflector is detected, is not only used as a correction parameter, but rather a switch between completely different evaluation methods.

The invention has been explained using the example of the voltage supply 38 as a supplementary circuit. The supplementary circuit, however, may also include other components. For example, an APD as the light receiver 26 is usually operated with a parallel capacity connected to ground and providing the necessary energy for pulse responses. In the base point to ground, the current can also be measured, in particular by means of a shunt resistor. This determines the current, in particular the average current by using a low pass filter, of the pulses during the light time of flight measurement. One advantage is that this tap does not measure homogenous ambient light, so that exclusively the signal of the pulse currents is integrated.

1. An optoelectronic sensor (10) for the detection of objects in a monitoring area (20), the sensor (10) comprising a light transmitter (12) for transmitting a light signal (16) into the monitoring area (20), a light receiver (26) for converting the light signal (22) reflected or remitted by an object into an electrical reception signal, a supplementary circuit (38) for operating the light receiver (26), and an evaluation (32) which is configured to determine a reception level of the reception signal and to determine object information about the object from the reception signal, wherein the evaluation unit (32) is further configured to determine the reception level from measurement information in the supplementary circuit (36, 38).

2. The sensor (10) according to claim 1,
wherein the supplementary circuit (38) comprises a voltage supply of the light receiver (26).

3. The sensor (10) according to claim 1,
wherein the supplementary circuit (38) comprises a capacitor for providing charge for pulse responses of the light receiver (26).

4. The sensor (10) according to claim 1,
wherein the evaluation unit (32, 52) is configured to compare the reception level with an expected reception level of a reflector.

5. The sensor (10) according to claim 1,
wherein a current measuring unit (48) is connected with the supplementary circuit (38).

6. The sensor (10) according to claim 5,
wherein the current measuring unit (48) comprises a shunt resistor.

7. The sensor (10) according to claim 1,
wherein the evaluation unit (32) is configured to determine a reception point in time of the light signal based on the reception signal and thus a distance of the object with a light time of flight method.

8. The sensor (10) according to claim 7,
wherein the evaluation unit (32) is configured to make a correction based on the reception level during determination of the distance.

9. The sensor (10) according to claim 7,
wherein the evaluation (32) is configured to select an evaluation algorithm for the light time of flight method in dependence on the reception level.

10. The sensor (10) according to claim 1,
wherein the evaluation unit (32) is configured to transmit a plurality of light pulses and to average the reception signals which are subsequently generated.

11. The sensor (10) according to claim 1,
wherein a low pass filter (50) is connected with the supplementary circuit (38), by means of which the measurement information is detected in an averaged manner.

12. The sensor (10) according to claim 1,
wherein a test circuit (54) is provided, which feeds an artificial test signal into the supplementary circuit (38) corresponding to a high reception level.

13. The sensor (10) according to claim 1,
which is configured as laser scanner having a deflection unit (18) by means of which the light signal (16, 22) periodically scans the monitoring area (20).

14. A method for the detection of objects in a monitoring area (20), wherein a light signal (16) is transmitted into the monitoring area (20) and a light signal (22) reflected or remitted by an object is converted into an electrical signal in a light receiver (26), wherein a reception level of the reception signal is determined and the reception signal is evaluated to determine object information about the object, wherein the reception level is determined from measurement information of a supplementary circuit (36, 38) for operating the light receiver (26).

15. The method according to claim 14,
wherein the measurement information is obtained from the supplementary circuit (38) by a current measurement (48) by means of a shunt resistor.

16. The method according to claim 14,
wherein the measurement information is obtained following a low pass filtering (50).
